(19) United States
(12) Patent Application Publication
(10) Pub. No.: US 2023/0232783 A1
(43) Pub. Date: Jul. 27, 2023

(54) Pet Carrying Backpack with Stabilizing Upper Body Support

(71) Applicant: MOWO Creative LLC, Hopkinton, MA (US)

(72) Inventor: Chong Wang, Hopkinton, MA (US)

(21) Appl. No.: 17/976,358

(22) Filed: Oct. 28, 2022

Related U.S. Application Data
(60) Provisional application No. 63/302,568, filed on Jan. 25, 2022.

(51) Int. Cl. A01K 1/02

(52) U.S. Cl. CPC A01K 1/029

(57) ABSTRACT

A pet carrying backpack is disclosed herein. The pet carrying backpack includes a backpack body having a bottom panel, a front panel, a rear panel, a right-side panel, and a left-side panel that collectively form a pocket for a pet to sit in. Shoulder straps are connected to and extend from the front panel to allow a person to carry the pet carrying backpack on their torso. A protrusion extends from a top side of the rear panel that supports the upper body of a pet. A left and a right strap extend from such protrusion, each strap having a securing mechanism such as a buckle connected on one end. The left strap wraps over a pet's left shoulder, and the right strap wraps over a pet's right shoulder, both straps connecting to a set of receptacles of a securing mechanism located on or extended from the front panel.

### BACKGROUND

### Technical Field

The present disclosure relates generally to a pet carrying backpack with stabilizing upper body support. More particularly the present disclosure relates to a pet carrier supported by a pet owner's shoulders.

### Description of Related Art

Backpack style, forward facing pet carriers have gained popularity in recent years. U.S. Pat. No. 9,781,901 to Rivera describes a pouch with shoulder straps and shock absorption bottom supports. U.S. Pat. No. 10,617,096 to Watson etc. describes a backpack style pet carrier with front-facing paw holes. While these devices allow the pet to travel with the owner on his back on hiking, biking, and other outdoor trips, they present a number of issues in their design.

First, the upper body of the pet, specifically from the pet's shoulder to head, is not safely constrained when carried in the device. When carried on its owner's back, the pet sees a view that it does not normally see and gets excited and distracted. One image is a dog rolling its head backward upside down to look behind its back. While it is adorable, it also presents safety risks as this motion shifts its center of gravity around that may throw the carrying person off balance when riding a bike. It is also a safety risk for the dog as it may hurt its neck or spine if the carrying person rides over a hump too quickly on a bike.

Next, the center of gravity of the pet sitting in the device tends to pull itself away from the carrying person's torso. This does not only make the pet feel insecure as it is tilting towards its back while sitting up, but also make the carrying experience uncomfortable for the person because the weight is unevenly distributed on his back and it would feel heavier than it actually weighs. Finally, the pet owner needs to carry separate gear, like a collar along with the pet carrier for when the pet is not in the carrier.

There are numerous other problems with the prior art, to which there a seemingly endless number of potential solutions. Therefore, what is needed is a pet carrying backpack with stabilizing upper body support having the following characteristics and benefits over the prior art.

### SUMMARY

The subject matter of this application may involve, in some cases, interrelated products, alternative solutions to a particular problem, and/or a plurality of different uses of a single system or article.

In one aspect, a pet carrying backpack is disclosed. In this aspect, the pet carrying backpack comprises a backpack body having a bottom panel, a front panel, a rear panel, a right-side panel, and a left-side panel that collectively form a pocket to receive a pet. The backpack also comprises shoulder straps disposed on and extending from the front panel and a protrusion extending from a top side of the rear panel. In this aspect, the backpack further comprises left and right straps, with one end of the left and right straps connected to the protrusion and another end of the left and right straps connected to either the front panel or the shoulder straps.

In another aspect, a pet carrying backpack is also disclosed. In this aspect, the pet carrying backpack comprises a backpack body having a bottom panel, a front panel, a rear panel, a right-side panel, and a left-side panel that collectively form a pocket to receive a pet. The backpack also comprises shoulder straps disposed on and extending from the front panel and a protrusion extending from a top side of the rear panel. In this aspect, the backpack further comprises a strap attached to the protrusion, and the strap is configured to form an adjustable collar. The adjustable collar is configured to form an opening from which a head of the pet may protrude, and the adjustable collar is connected to the front panel of the backpack body.

In yet another aspect, a pet carrying backpack is also disclosed. In this aspect, the pet carrying backpack comprises a backpack body having a bottom panel, a front panel, a rear panel, a right-side panel, and a left-side panel that collectively form a pocket to receive a pet. The backpack also comprises shoulder straps disposed on and extending from the front panel and a protrusion extending from a top side of the rear panel. In this aspect, the protrusion bifurcates into two forks, and each one of the two forks wraps over the shoulders or arms of the pet and connects to a securing mechanism attached to either the front panel or the plurality of shoulder straps.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 shows a perspective view of a pet carrying backpack in one exemplary embodiment.

FIG. 2 shows a perspective view of the pet carrying backpack of FIG. 1 with the top straps unbuckled.

FIG. 3 shows a perspective view of the pet carrying backpack of FIG. 1 with the back of the backpack opened.

FIG. 4 shows a perspective view of the pet carrying backpack of FIG. 1 loaded with a dog.

FIG. 5a shows a right-side view of the pet carrying backpack of FIG. 1 loaded with a dog sitting upright.

FIG. 5b shows a right-side view of the pet carrying backpack of FIG. 1 loaded with a dog bending backwards without the top straps fastened.

FIG. 6a shows a perspective view of a pet carrying backpack in another exemplary embodiment.

FIG. 6b shows a right-side view of the pet carrying backpack of FIG. 6a loaded with a dog.

FIG. 7 shows a perspective view of a pet carrying backpack with an extendable upper body support, according to one exemplary embodiment.

FIG. 8 shows a perspective view of a pet carrying backpack, according to another exemplary embodiment.

FIG. 9 shows a right-side view of the pet carrying backpack of FIG. 8, loaded with a dog.

FIG. 10 shows a perspective view of a pet carrying backpack, according to another exemplary embodiment.

FIG. 11 shows a perspective view of the pet carrying backpack of FIG. 10, with the upper body support unbuckled.

FIG. 12 shows a front view of the pet carrying backpack of FIG. 10, with the upper body support unbuckled.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a pet carrying backpack with stabilizing upper body support. More particularly the present disclosure relates to a pet carrier supported by a pet owner's shoulders. The present disclosure solves a number of identified problems present in the prior art. For example, the present disclosure provides a backpack style pet carrier that has an adequate upper body constraining system, like a safety belt, to allow basic, comfortable movement of the pet while providing safety constraint to the upper body of the pet. Additionally, the present disclosure also provides a backpack style pet carrier that can accommodate a range of pet sizes through both an adjustable constraining system and an adjustable carrying pouch. The present disclosure further incorporates a system to manage the position and posture of the pet while sitting in the carrier, so it is an equally enjoyable experience for the carrying person. Finally, the backpack style pet carrier disclosed herein comprises an integrated collar for the pet that is detachable when the pet is not carried in the carrier.

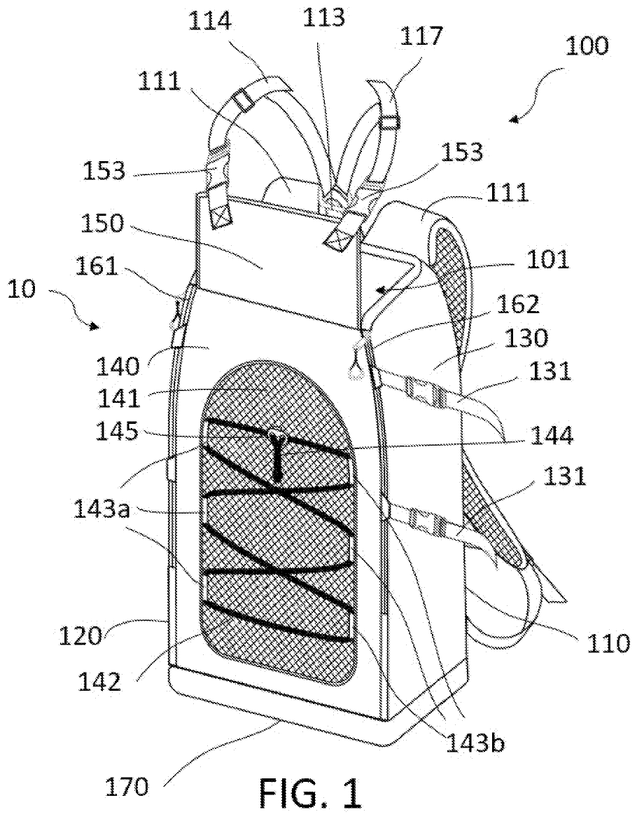

FIG. 1 shows a perspective view of a pet carrying backpack 100 in one embodiment. A front panel 110, a left-side panel 120, a right-side panel 130, a rear or back panel 140, and a bottom panel 170 are adhered to, fastened to, or sewn to each other to collectively form a pocket 10 to carry a pet. An opening 101 is formed on the top side of the pocket 10 to allow the upper body of a pet protrude. In other embodiments, one or more of the panels 110, 120, 130, 140 and/or 170 may be formed as a single piece. Shoulder straps 111 may be fastened to front panel 110 in any suitable manner as known in the art.

A protrusion 150 is adhered to, fastened to, or sewn to the top side of the back panel 140 permanently. In other embodiments, the protrusion 150 may be attached to the back panel 140 in a detachable manner using a zipper or any suitable manner as known in the art. In some embodiments, the protrusion 150 may be formed with the back panel 140 as a single piece. The protrusion 150 may be formed of any suitable material including natural or synthetic materials as known or later developed. The protrusion 150 may comprise padded material such as foam to provide comfort to the pet carried inside the pocket 10. In other embodiments, the protrusion 150 may comprise a stiffening member such as a plastic frame or a metal frame. The stiffening member may be internal to the protrusion 150, or attached to protrusion 150 externally by adhesives, sewing, fastening or another suitable manner as known in the art.

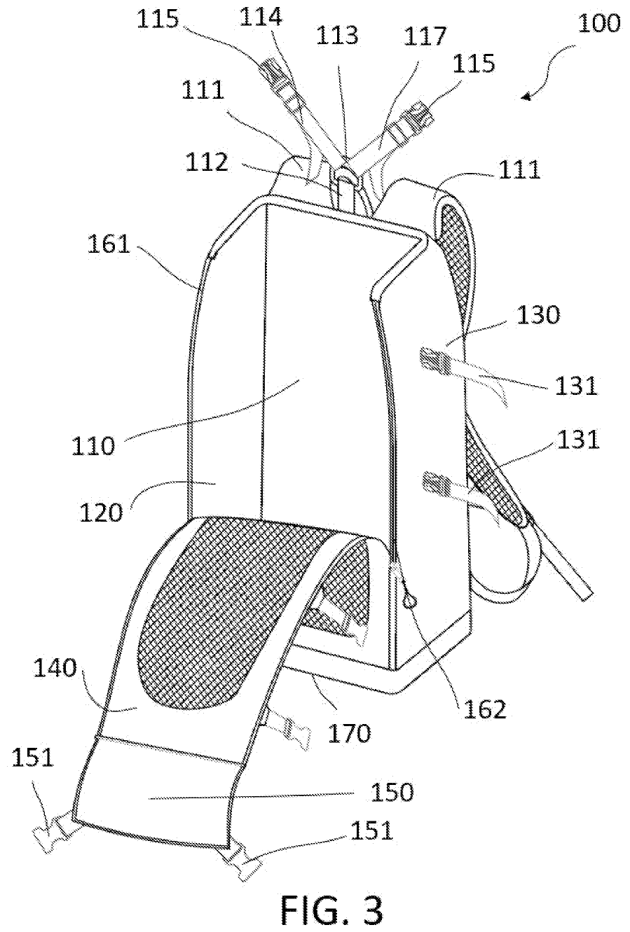

The protrusion 150 is connected to the front panel 110 by a set of at least one left strap 114 and one right strap 117. The left strap 114 and the right strap 117 may be individually adjustable in length to control the distance between the protrusion 150 and the front panel 110 to accommodate a pet of various sizes. In the present embodiment, and still referring to FIG. 1, the left strap 114 and the right strap 117 are connected to the front panel 110 permanently, bridged by a metal loop 113 and a strap 112 (shown in FIG. 3). One end of the left strap 114 and one end of the right strap 117 are fastened to the metal loop 113. The metal loop 113 is fastened to one end of the strap 112. The other end of the strap 112 is fastened to the front panel 110.

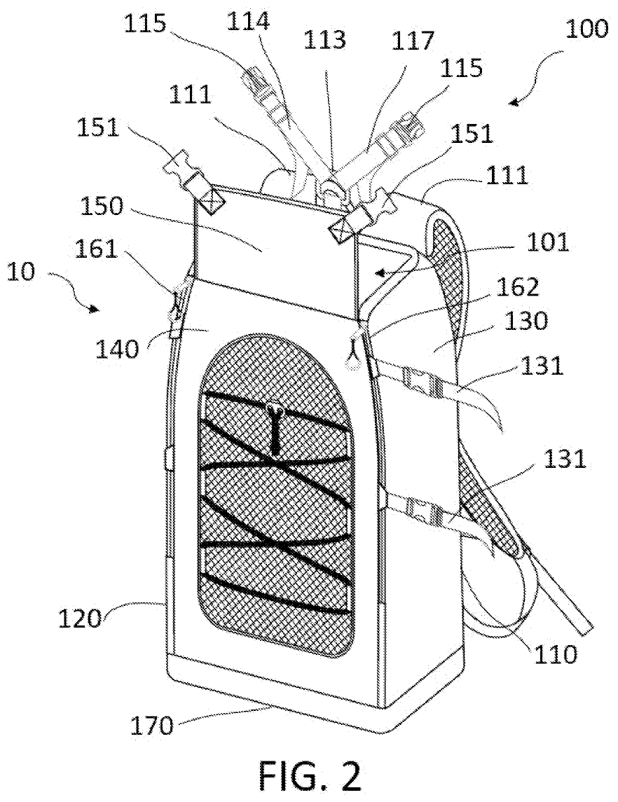

In some embodiments, the left strap 114 and the right strap 117 may be fastened to the front panel 110 directly. In other embodiments, the left strap 114 and the right strap 117 may be fastened together first before being fastened to the front panel 110 jointly. In the present embodiment shown in FIG. 1, the left strap 114 and the right strap 117 are attached to the protrusion 150 through snap-fit buckles 153 that can be detached. FIG. 2 shows a perspective view of the pet carrying backpack of FIG. 1 with the buckles 153 opened or detached. The left strap 114 and the right strap 117 each comprises a male buckle member 115 that can be inserted into and secured by a female buckle member 151, which is attached to the protrusion 150. In some embodiments, the male and the female buckle members 115 and 151 can swap their locations in any of the buckles 153 (FIG. 1). For example, one embodiment may comprise a male buckle member 115 attached to the protrusion 150 and a female buckle member 151 attached to one of the left or right straps 114 and 117, respectively.

In other embodiments, the left strap 114 and the right strap 117 may be attached to the protrusion 150 through other suitable detachable securing mechanisms as known in the art. In some embodiments, one ends of the left strap 114 and the right strap 117 may be attached to the protrusion 150 permanently by sewing or other suitable methods known in the art, while the other ends of the left strap 114 and the right strap 117 may be attached to the front panel 110 through any suitable detachable mechanisms as known in the art including snap-fit buckles 153. In other embodiments, both ends of the left strap 114 and the right strap 117 may be attached permanently to the front panel 110 and the protrusion 150, respectively. In other embodiments yet, both ends of the left strap 114 and the right strap 117 may be attached to the front panel 110 and the protrusion 150, respectively, through any suitable detachable securing mechanisms as known in the art, including snap-fit buckles 153.

FIG. 3 shows a perspective view of the pet carrying backpack of FIG. 1 with one left zipper 161 and one right zipper 162 unzipped. The pet carrying backpack 100 may comprise at least one vertical zipper 161 or 162, which when unzipped helps to facilitate ingress and egress of a pet into the pocket 10. In this embodiment, the left zipper 161 connects the left-side panel 120 and the back panel 140, and the right zipper 162 connects the right-side panel 130 and the back panel 140. In other embodiments, a vertical zipper may be located on any of the left-side panel 120, the right-side panel 130, and the back panel 140.

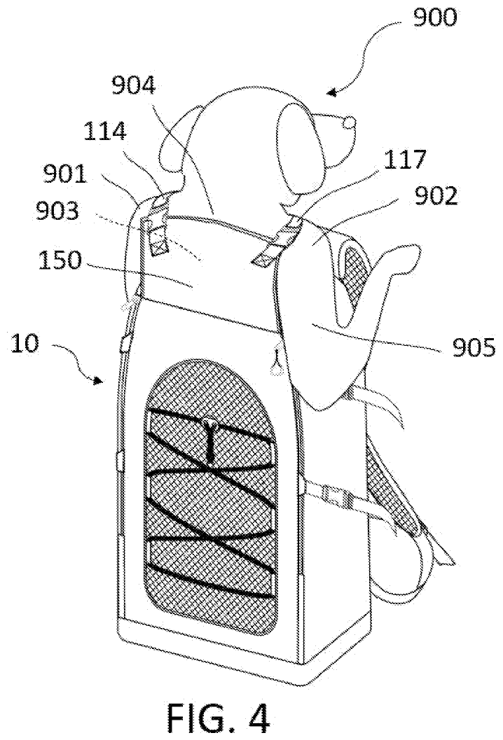

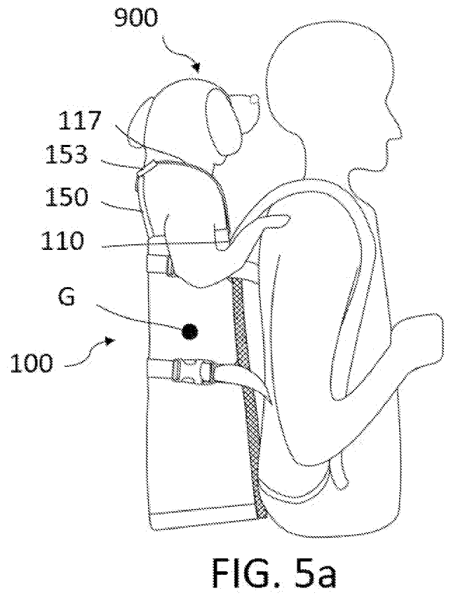

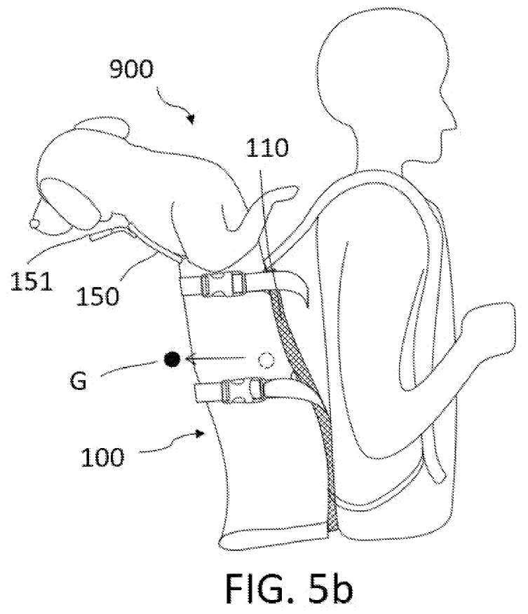

FIG. 4 shows a perspective view of the pet carrying backpack of FIG. 1 carrying a dog 900. The dog's lower body is contained in the pocket 10, and its upper body protrudes from the opening 101. When buckled in, the left strap 114 wraps over the dog's left shoulder 901 and the right strap 117 wraps over the dog's right shoulder 902, both straps together pulling the extrusion 150 up and against the dog's upper back 903 and neck 904. The protrusion 150 provides support to the dog's upper body and limits the range of movement by the dog's upper body, so the dog cannot make excessive movement bending backwards as shown in FIG. 5b with the straps 114, 117 unbuckled, detached, or absent.

FIG. 5a shows a right-side view of the pet carrying backpack 100 of FIG. 1 loaded with a pet 900 sitting upright, which is the intended posture of the pet when carried in the backpack. The position of the center of gravity G of the pet 900 and the pet carrying backpack 100 stays stationary relative to the transporter's torso. FIG. 5b shows a right-side view of a pet 900 bending backwards in a pet carrying backpack without fastening the protrusion 150 to the front panel 110, as previously mentioned. When the pet 900 bends its upper body backwards, the center of gravity G of the pet and the pet carrying backpack 100 shifts away from the transporter's torso. If the pet 900 bends its upper body backwards too suddenly, which frequently happens when it is excited by a bypassing person or object, the shifting of the center of gravity G may throw the transporter off balance and endanger the transporter in situations such as when the transporter is riding a bicycle. The protrusion 150 tying to the front panel 110 prevents this from happening and improves the safety of both the transporter and the carried pet 900. The left strap 114 and the right strap 117 constrain the dog's upward and sidewise movement to keep the dog inside the backpack pocket 10, thus further stabilizing the pet 900 inside the backpack. The pet's arms 905 (FIG. 4) is not constrained and is free to move around to any comfortable position.

The pet carrying backpack 100 may further comprise at least one sizing strap 131, as shown in the FIGS. 1-3. The sizing strap 131 is adjustable in length such that when reduced in length, the sizing strap 131 reduces the circumferential size of the pocket 10 to fit the pet carried therein more snuggly. In the present embodiment, as shown in FIG. 1, one end of the sizing strap 131 is attached to the back panel 140, and the other end of the sizing strap 131 is attached to the front panel 110. In other embodiments, the sizing strap 131 may be attached to at least one of the front panel 110, the left-side panel 120, the right-side panel 130, and the back panel 140, or the combination thereof.

The pet carrying backpack 100 may comprise of other mechanisms to reduce the circumferential size of the pocket 10. In one exemplary embodiment in FIG. 1, a cord 142 travels through a set of loops 143a and 143b in a zig-zag path with its ends locked by a push-to-release cord lock 145 that locks the length of the cord that is in the zig-zag path. The loops 143a and 143b are fastened to the back panel 140. As a greater portion of the cord being pulled to the other side of the cord lock 145, the length of the cord that is in the zig-zag path is reduced, pulling the loops 143a closer to the loops 143b and reducing the circumferential size of the pocket 10. The pet carrying backpack 100 may also comprise of vented areas on the back panel 140. The vented areas may comprise of webbed material 141 to allow for largely unobstructed airflow into the interior of the backpack 100 to keep a pet carried therein cool. Any or all of the left-side panel 120, right-side panel 130, and the back panel 140 may comprise webbed material 141.

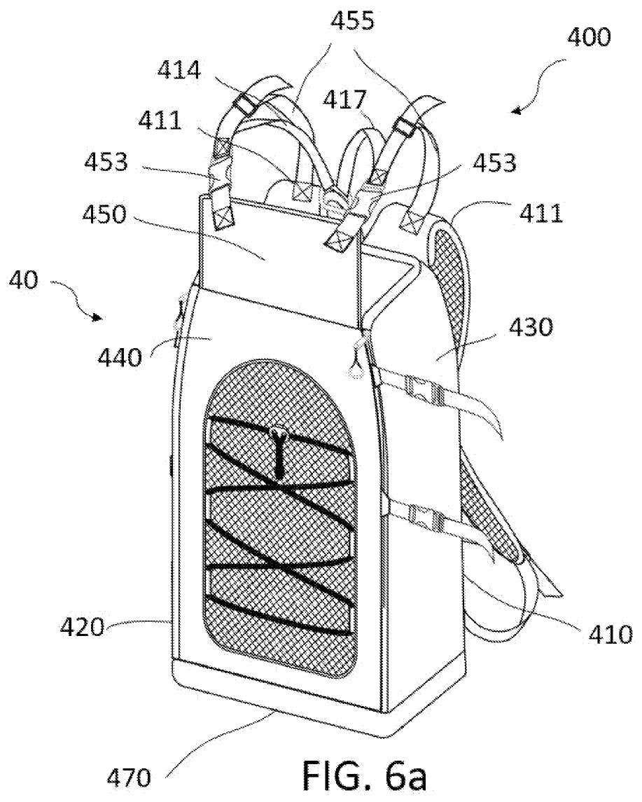

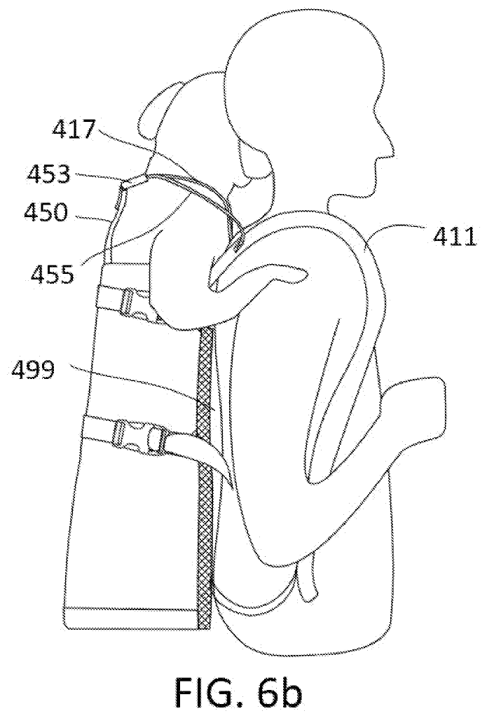

Turning now to FIG. 6a, which shows a perspective view of a pet carrying backpack 400, according to another exemplary embodiment. The pet carrying backpack 400 shares many similar features as the backpack 100 described above, so a full description of like features will largely be omitted. For example, the pet carrying backpack 400 comprises a front panel 410, a left-side panel 420, a right-side panel 430, a back panel 440, and a bottom panel 470 that collectively forms a pocket 40 to accept and contain a pet. Backpack 400 further comprises a protrusion 450 that is adhered to, fastened to, or sewn to the top side of the back panel 440. A left strap 414 and a right strap 417 connect the front panel 410 and the protrusion 450. Backpack 400 further comprises a pair of load lifter straps 455 that are individually adjustable in length. In one embodiment, one end of each of the load lifter straps 455 are fastened to each of the shoulder straps 411 by sewing or other suitable methods known in the art, while the other end of each of the load lifter straps 455 are fastened to the protrusion 450 through detachable snap-fit buckles 453. In other embodiments, one end of each of the load lifter straps 455 are fastened to each of the shoulder straps 411, while the other end of each of the load lifter straps 455 are fastened to the front panel 410.

FIG. 6b shows a right-side view of backpack 400 of FIG. 6a loaded with a dog. The load lifter straps 455 are adjusted to appropriate lengths, pulling the dog and backpack 400 towards the torso of the transporter and minimizing the gap 499 between the backpack 400 and the torso of the transporter. This relieves the transporter's shoulders from some of the weight of the backpack 400 to make the transporter more comfortable. It may also provide the pet with a sense of security being closer to its transporter.

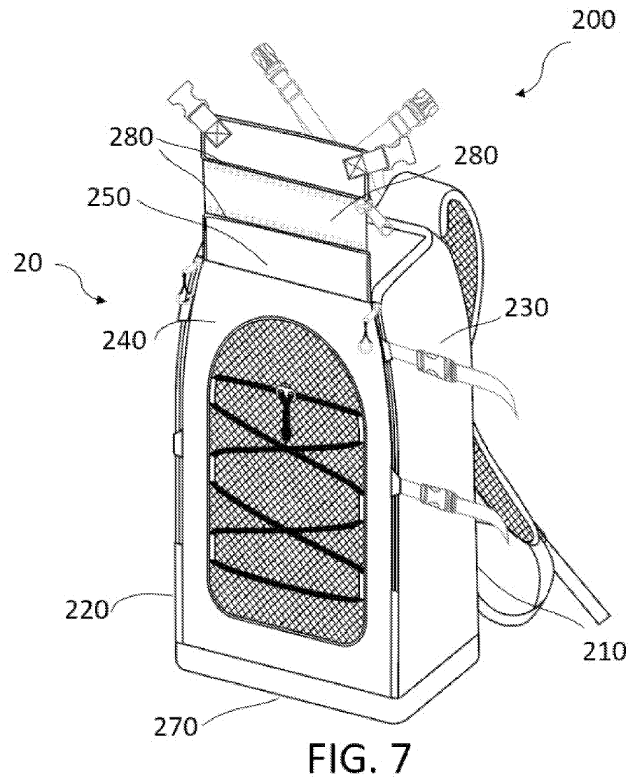

FIG. 7 shows a perspective view of a pet carrying backpack 200, according to another exemplary embodiment. The pet carrying backpack 200 shares many similar features as the backpack 100 described above, so a full description of like features will largely be omitted. For example, the pet carrying backpack 200 comprises a front panel 210, a left-side panel 220, a right-side panel 230, a back panel 240, and a bottom panel 270 that collectively forms a pocket 20 to accept and contain a pet. Backpack 200 further comprises a protrusion 250 that is adhered to, fastened to or sewn to the top side of the back panel 240. The protrusion 250 is adjustable in length to accommodate pets of various body length. In one exemplary embodiment, the protrusion 250 comprises of at least one zipper 280 which may release additional material 281 when unzipped to increase the length of the protrusion 250.

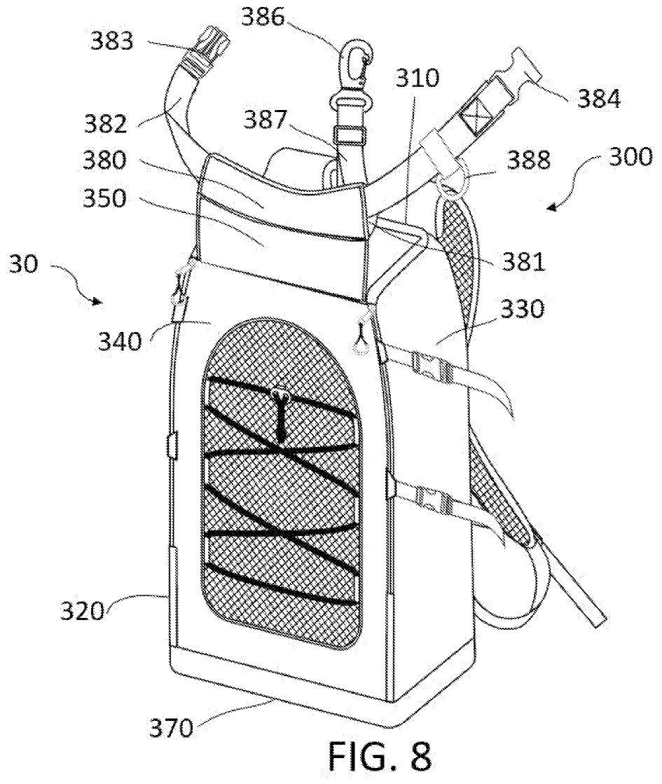

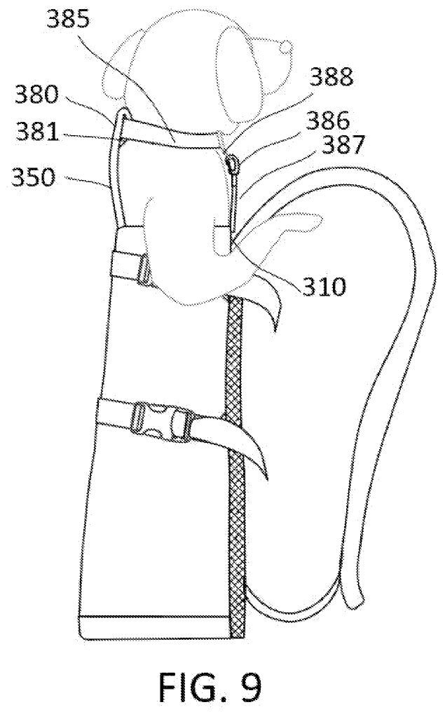

FIG. 8 shows a perspective view of a pet carrying backpack 300, according to yet another exemplary embodiment. FIG. 9 shows a right-side view of the pet carrying backpack 300 of FIG. 8, carrying a dog. The pet carrying backpack 300 shares many similar features as the backpack 100 and 200 described above, so a full description of like features will largely be omitted. For example, the pet carrying backpack 300 comprises a front panel 310, a left-side panel 320, a right-side panel 330, a back panel 340, and a bottom panel 370 that collectively forms a pocket 30 to accept and contain a pet. Backpack 300 comprises a protrusion 350 that is adhered to, fastened to, or sewn to the top side of the back panel 340.

The protrusion 350 further comprise a top portion 380 forming a loop 381 to accept and contain a strap 382. In some embodiments the strap 382 is fastened to the top portion 380 by sewing and the top portion 380 may be detachable from the protrusion 350 using a zipper or any suitable manner as known in the art. In other embodiments, the strap 382 is attached to the top portion 380 through at least one snap-fit buckle or any other suitable detachable securing mechanisms as known in the art. The strap 382 may comprise of one male buckle member 383 and one female buckle member 384, which when snapped into one another form a collar 385 (FIG. 9) through which a pet's head protrude. The size of the collar 385 may be adjustable. The collar 385 may be attached to the front panel 310 through a hook 386 attached to a strap 387 fastened to the front panel 310, and a metal or plastic loop 388 fastened to the collar 385. The length of the strap 387 may be adjustable.

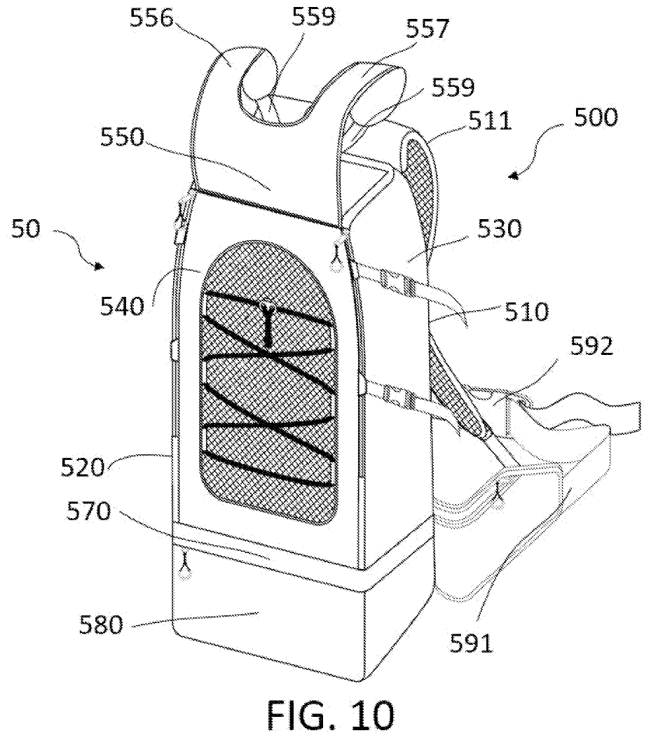

FIG. 10 shows a perspective view of a pet carrying backpack 500, according to yet another exemplary embodiment. The pet carrying backpack 500 shares many similar features as the previously disclosed backpacks 100, 200, 300, and 400, so a full description of like features will largely be omitted. For example, the pet carrying backpack 500 comprises a front panel 510, a left-side panel 520, a right-side panel 530, a back panel 540, and a bottom panel 570 that collectively forms a pocket 50 to accept and contain a pet. Backpack 500 further comprises a protrusion 550 that is adhered to, fastened to, or sewn to the top side of the back panel 540.

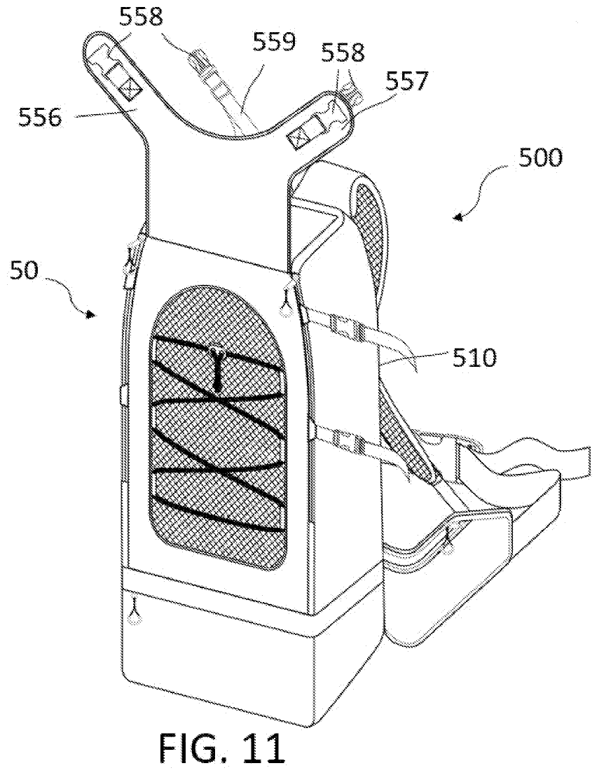

The protrusion 550 bifurcates into one left fork 556 and one right fork 557, both fastened through snap-fit buckles 558 (shown in FIG. 11) to a set of straps 559 connected to the front panel 510. When a dog is carried in the backpack 500, the left fork 556 wraps over the left shoulder of the dog and the right fork 557 wraps over the right shoulder of the dog. The straps 559 are adjustable in lengths. In some embodiments, the straps 559 may be fastened to the shoulder straps 511. In other embodiments, the left fork 556 and the right fork 557 may be fastened directly to the front panel 510 or to the shoulder straps 511 without the straps 559. FIG. 11 shows a perspective view of backpack 500 of FIG. 10, with the left fork 556 and the right fork 557 detached from the straps 559.

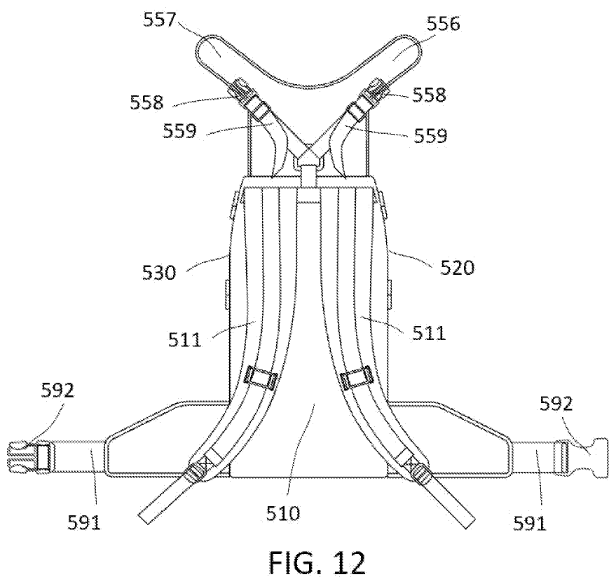

Finally, FIG. 12 shows a front view of backpack 500 of FIGS. 10 and 11. The backpack 500 may further comprise a compartment 580 for additional storage room. The backpack 500 may further comprise waist straps 591. The waist straps 591 are selectively connected about the transporter's waist via a snap-fit buckle 592.

While several variations of the present disclosure have been illustrated by way of example in preferred or particular embodiments, it is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. A pet carrying backpack comprising:
a backpack body having a bottom panel, a front panel, a rear panel, a right-side panel, and a left-side panel that collectively form a pocket to receive a pet;
a plurality of shoulder straps disposed on and extending from the front panel;
a protrusion extending from a top side of the rear panel; and
a left strap and a right strap, a first end of the left strap and a first end of the right strap connected to the protrusion, and a second end of left strap and a second end of the right strap connected to at least one of the front panel or the plurality of shoulder straps.

2. The pet carrying backpack of claim 1, wherein the left strap and the right strap are adjustable.

3. The pet carrying backpack of claim 1, further comprising a vertical zipper disposed on at least one of the rear panel, the left-side panel, or the right-side panel, wherein the vertical zipper facilitates an ingress or an egress of the pet to or from the pocket.

4. The pet carrying backpack of claim 1, further comprising an adjustable sizing strap disposed on at least one of the rear panel, the left-side panel, or the right-side panel.

5. A pet carrying backpack comprising:
a backpack body having a bottom panel, a front panel, a rear panel, a right-side panel, and a left-side panel that collectively form a pocket to receive a pet;
a plurality of shoulder straps disposed on and extending from the front panel;
a protrusion extending from a top side of the rear panel;
a strap attached to the protrusion, the strap configured to form an adjustable collar, wherein the adjustable collar is configured to form an opening from which a head of the pet may protrude; and
the adjustable collar connected to the front panel of the backpack body.

6. The pet carrying backpack of claim 5, wherein the adjustable collar is detachable from the protrusion.

7. The pet carrying backpack of claim 5, wherein a length of the protrusion is adjustable.

8. The pet carrying backpack of claim 5, wherein the protrusion comprises a stiffening member disposed within the protrusion.

9. The pet carrying backpack of claim 5 further comprising a vertical zipper disposed on at least one of the rear panel, the left-side panel, or the right-side panel, wherein the vertical zipper facilitates an ingress or an egress of the pet to or from the pocket.

10. The pet carrying backpack of claim 5 further comprising an adjustable sizing strap disposed on at least one of the rear panel, the left-side panel, or the right-side panel.

11. The pet carrying backpack of claim 5 further comprising a load lifter strap having a first end attached to one of the plurality of shoulder straps, and a second end of the load lifter strap attached to at least one of the front panel, the left-side panel, the right-side panel, the rear panel, the protrusion, or the adjustable collar.

12. A pet carrying backpack comprising:
a backpack body having a bottom panel, a front panel, a rear panel, a right-side panel, and a left-side panel that collectively form a pocket configured to receive and contain a pet;
a plurality of shoulder straps disposed on and extending from the front panel; and
a protrusion extending from a top side of the rear panel, wherein a top end of the protrusion bifurcates into two forks, each one of the two forks wrapping over a left shoulder, a right shoulder, or arms of the pet and connecting to a securing mechanism attached to at least one of the front panel or the plurality of shoulder straps.

13. The pet carrying backpack of claim 12, wherein the protrusion is detachable.

14. The pet carrying backpack of claim 12, wherein the two forks comprise a snap-fit buckle, the snap-fit buckle enabling the two forks to connect to each other and the securing mechanism.

15. The pet carrying backpack of claim 12 further comprising a vertical zipper disposed on at least one of the rear panel, the left-side panel, or the right-side panel, wherein the vertical zipper facilitates an ingress or an egress of the pet to or from the pocket.

16. The pet carrying backpack of claim 12 further comprising an adjustable sizing strap disposed on at least one of the rear panel, the left-side panel, or the right-side panel.

17. The pet carrying backpack of claim 12 further comprising a load lifter strap having a first end attached to one of the plurality of shoulder straps, and a second end of the load lifter strap attached to at least one of the front panel, the left-side panel, the right-side panel, the rear panel, the protrusion, or the adjustable collar.
